(19) United States
(12) Patent Application Publication
(10) Pub. No.: US 2018/0357411 A1
(43) Pub. Date: Dec. 13, 2018

(54) Authentication Of A Device

(71) Applicant: CA, Inc., New York, NY (US)

(72) Inventors: Ramkumar Krishnamurthy, Bangalore (IN); Mahabaleshwara Hegde, Bangalore (IN)

(21) Appl. No.: 15/621,075

(22) Filed: Jun. 13, 2017

(51) Int. Cl. G06F 21/44; H04L 29/06; H04W 12/06

(52) U.S. Cl. CPC G06F 21/445; H04L 63/0869; H04W 12/06; H04L 63/083

(57) ABSTRACT

According to an embodiment of the present disclosure, a method by an authentication server is disclosed that includes receiving a first request to access an enterprise network. The first request includes a first digital fingerprint and a characteristic associated with the client device. The authentication server determines that the first digital fingerprint matches a second digital fingerprint stored in a memory. A request for a challenge is received from the client device. The challenge and a password that is encrypted using the characteristic are transmitted to the client device. A signed challenge is received from the client device. The signed challenge is decrypted. The client device is authenticated by comparing the signed challenge to the challenge previously transmitted to the client device. In response to determining that the signed challenge matches the challenge previously transmitted to the client device, the client device is allowed to access the enterprise network.

### BACKGROUND

The present disclosure relates to interfaces and, in particular, to a method, apparatus, and executable instructions for authenticating a device for accessing an enterprise network.

### SUMMARY

The present disclosure relates to interfaces and, in particular, to a method, apparatus, According to an embodiment of the present disclosure, a method by an authentication server includes receiving, from a client device, a first request to access an enterprise network. The first request comprises a first digital fingerprint associated with the client device and a characteristic associated with the client device. It is determined, by the authentication server, that the first digital fingerprint received with the first request matches a second digital fingerprint stored in a memory associated with the authentication server. A request for a challenge is received from the client device, and the challenge is transmitted to the client device. A password that is encrypted using the characteristic associated with the device is transmitted to the client device. A signed challenge is received from the client device. The signed challenge includes an encrypted version of the challenge. The signed challenge is decrypted and the client device is authenticated by comparing the signed challenge received from the client device to the challenge previously transmitted to the client device. In response to determining that the signed challenge matches the challenge previously transmitted to the client device, the client device is allowed to access the enterprise network.

According to another embodiment of the present disclosure, a method by a client device includes transmitting, to the authentication server, a first request to access an enterprise network. The first request comprises a first digital fingerprint associated with the client device and a characteristic associated with the client device. A request for a challenge is transmitted to the authentication server. The challenge and a password that is encrypted using the characteristic associated with the client device are received from the authentication server. The characteristic is used to decrypt the password and the password is used to access a private key to generate a signed version of the challenge. The signed version of the challenge is transmitted to the authentication server and access to the enterprise network is received.

According to another embodiment of the present disclosure, an authentication server includes a memory storing instructions and processing circuitry operable to execute the instructions to cause the processing circuitry to receive, from a client device, a first request to access an enterprise network. The first request comprises a first digital fingerprint associated with the client device and a characteristic associated with the client device. The processing circuitry determines that the first digital fingerprint received with the first request matches a second digital fingerprint stored in a memory associated with the authentication server. The processing circuitry receives, from the client device, a request for a challenge and transmits the challenge to the client device. The processing circuitry transmits, to the client device, a password that is encrypted using the characteristic associated with the client device. A signed challenge is received from the client device. The signed challenge comprises an encrypted version of the challenge. The processing circuitry decrypts the signed challenge and authenticates the client device by comparing the signed challenge received from the client device to the challenge previously transmitted to the client device. In response to determining that the signed challenge matches the challenge previously transmitted to the client device, the processing circuitry allows the client device to access the enterprise network.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-5, like numerals being used for corresponding parts in the various drawings.

FIG. 1 illustrates an environment for authenticating a client device for accessing an enterprise network, according to a non-limiting embodiment of the present disclosure.

FIG. 2 illustrates a sequence diagram for enrolling a client device for device authentication, according to a non-limiting embodiment of the present disclosure.

FIG. 3 illustrates authentication server for authenticating a client device for accessing an enterprise network, according to a non-limiting embodiment of the present disclosure.

FIG. 4 illustrates a flow diagram depicting a process for authenticating a client device for accessing an enterprise network, according to a non-limiting embodiment of the present disclosure.

FIG. 5 illustrates a client device that may seek access to an enterprise network, according to a non-limiting embodiment of the present disclosure.

FIG. 6 illustrates a flow diagram depicting a process for seeking access to an enterprise network, according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor and/or processing circuitry of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

An enterprise often provides enterprise-issued devices to its employees and other authorized workers. The employees may use the enterprise-issued devices to access the enterprise network and the resources thereon from remote locations that are not associated with the enterprise. For example, an employee may use an enterprise-issued device to access the enterprise network when working from home. As such, when receiving requests to access the enterprise network and the resources thereon, an enterprise network may wish to identify whether the request is from a particular device which belongs to the enterprise.

Authentication credentials such as those issued by certificate authorities are associated with a user of a computing device, rather than the computing device itself. Additionally, such services are typically quite expensive. However, by tying authentication credentials to a domain like abc.com and associating the authentication credentials to a machine, an enterprise network may confirm if a given machine belongs to the organization or not. Consequently, if a computing device belongs to the organization, then the computing device may be allowed access over a virtual private network (VPN) as though the user is in the corporate LAN. If the computing device is determined to not belong to the organization, access for the computing device may be restricted or denied altogether.

Accordingly, there is a need in the marketplace for an authentication solution with the ability to determine whether a computing device seeking access to an enterprise network is an enterprise-issued computing device. The present disclosure provides, inter alia, a solution to overcome the weaknesses of traditional user-based authentication approaches. The present disclosure describes, inter alia, a more secure system for authenticating a computing device prior to allowing access to an enterprise network and its resources to a requesting computing device. Embodiments of the present disclosure may address the above problems, and other problems, individually and collectively.

Certain embodiments of the present disclosure may provide one or more technical advantages. For example, certain embodiments may provide cost effective transparent device authentication using a unique client identity. Another advantage may be that certificate management overhead is minimized. For example, renewal and reissue of authentication certificates with an authentication authority is not required. Still another advantage may be that enterprise servers, laptops, other devices, data centers and cloud vendors can adopt the solution easily. Another advantage still may be that authentication protocol is centrally deployed.

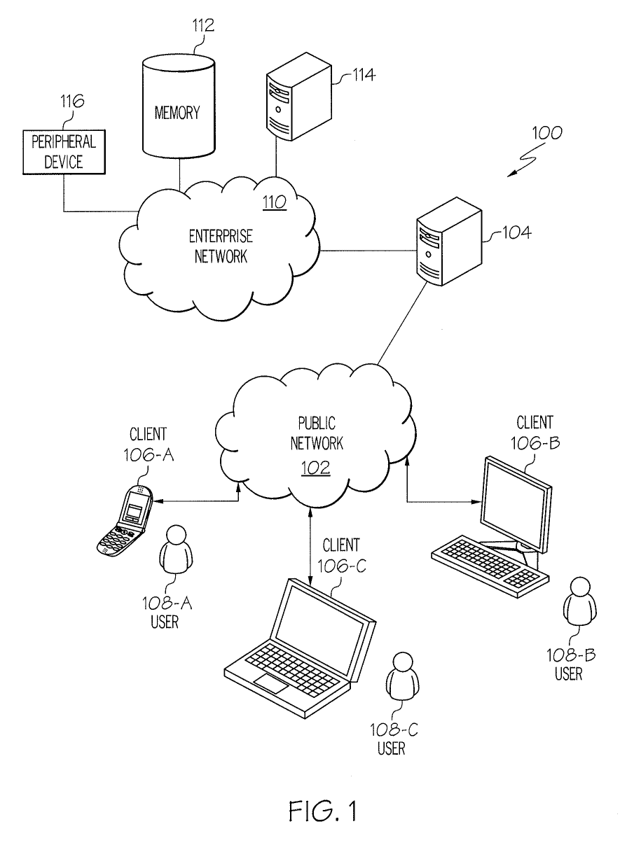

FIG. 1 illustrates an exemplary distributed system 100 in which the subject matter of the disclosure can function. The system 100 generally includes a public network 102 communicatively coupling an authentication server 104 to one or more client devices 106. Users 108 may be present on client devices 106 to access enterprise network 110 and enterprise resources such as files, data, and applications stored on memory 112 or processing services provided by a server 114 upon proper authentication.

The public network 102 generally refers to any interconnecting system capable of transmitting audio, video, signals, data, messages, or any combination of the preceding. Further, the public network 102 may include all, or a portion of a public switched telephone network (PSTN), a public or private network, a local area network (LAN), a metropolitan area network (MAN), a wide area network (WAN), a local, regional, or global communication or computer network such as the Internet, a wired or wireless network, other suitable communication link, or any combination of similar systems.

Enterprise network 110 may be a private network that is connected via authentication server 104 to public network 102. Enterprise network 110, which may include any number of subnetworks, provides access to a variety of enterprise resources. For example, enterprise network 110 may provide access to data and files stored in a memory 112. According to certain embodiments, memory 112 may include storage media, such as hard disk drives, volatile or non-volatile memory, optical disk storage devices, or any other storage devices, including removable storage devices. As another example, enterprise network 110 may provide access to peripheral device 116, which may include any type of peripheral device for use in enterprise network 110. In particular embodiments, peripheral devices may include a printer, scanner, and communication device, as examples. As still another example, enterprise network 110 may provide access to applications and other information provided by one or more enterprise servers 114.

Enterprise network 110 and public network 102 may transmit information in packet flows in one embodiment. A packet flow includes one or more packets sent from a source to a destination. A packet may comprise a bundle of data organized in a specific way for transmission, and a frame may comprise the payload of one or more packets organized in a specific way for transmission. A packet-based communication protocol, such as Internet Protocol (IP), may be used to communicate the packet flows.

A packet flow may be identified in any suitable manner. As an example, a packet flow may be identified by a packet identifier giving the source and destination of the packet flow. A source may be given by an address, such as the IP address, port, or both. Similarly, a destination may be given by an address, such as the IP address, port, or both.

According to certain embodiments, enterprise network 110 and public network 102 may utilize protocols and technologies to transmit information. Example protocols and technologies include those described by the Institute of Electrical and Electronics Engineers, Inc. (IEEE) 802.xx standards, such as 802.11, 802.16, or WiMAX standards, the International Telecommunications Union (ITU-T) standards, the European Telecommunications Institute (ETSI) standards, Internet Engineering Task Force (IETF) standards, the third generation partnership project (3GPP) standards, or other standards.

The authentication server 104 may be any network point suitable to couple a client device 106 to enterprise network 110 via a public network 102. According to certain embodiments, authentication server 104 may include a file server, a domain name server, a proxy server, a web server, a computer workstation, or any other device providing access to enterprise network 110. Further, the server 104 may use any appropriate operating system, such as MS-DOS®, MAC-OS®, WINDOWS®, UNIX®, or any other operating system currently in existence or developed in the future. According to certain embodiments, authentication server 104 operates as an access point to enterprise network 110 and, thus, performs the authentication of a client device 106 prior to allowing client device 106 to access enterprise network resources.

As used here, the term “client” and “client devices”, as with client devices 106, generally refers to any suitable device operable to communicate with the server 104 through the network 102. Client devices 106 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the server 104 through the network 102. Further, client devices 106 may employ any known operating systems such as MS-DOS®, PC-DOS®, OS-2®, MAC-OS®, or any other appropriate operating systems.

According to certain embodiments, an enterprise may allow users 108 to access memory 112, file servers 114, and peripheral devices 116 such as printers, communication hardware, and input/output devices. In order to restrict access to such shared resources, security measures for preventing unauthorized access to enterprise network 110 may be performed by authentication server 104. Specifically, authentication server 104 may be configured to obtain and verify authentication credentials from a requesting client device 106 before granting access to enterprise network 110 or to certain portions of enterprise network 110. In contrast to previous systems, which focused on the authentication of users of computing devices, authentication server 104 of system 100 requires verification and authentication of the computing devices 106 as enterprise-issued devices prior to providing access to enterprise network 110.

In particular embodiments of the invention, communications between client device 106 and authentication server 104 may be effected according to one or more secure wireless communication protocols or WLAN protocols, such as portions or all of the Wired Equivalent Privacy (WEP) protocol, the Robust Security Network (RSN) associated with the IEEE 802.11 protocol, the IEEE 802.1x protocol, the Advanced Encryption Standard (AES), the Temporal Key Integrity Protocol (TKIP), Extensible Authentication Protocol over LAN (EAPOL) algorithms or protocols (such as EAP-TTLS, PEAP, or CISCO's LEAP or EAP-FAST protocols, for example), WiFi Protected Access (WPA) protocol, WiFi Protected Access Pre-shared key (WPA-PSK) protocol, WiFi Protected Access Version 2 (WPA2) protocol, or WiFi Protected Access Version 2 Pre-shred key (WPA2-PSK) protocol, for example.

In various embodiments, an authentication program and associated protocol may be used to identify client device 106. As described in more detail below, the authentication program may be used by client device 106 to generate a digital fingerprint that may be used for authentication purposes. In certain embodiments, the digital fingerprint may be combined with a host name and/or another characteristic of client device 106 to provide authentication of client device 106. The host name may be a corporate assigned name that uniquely identifies client device 106. According to certain embodiments, the host name may be mapped to a particular user 108 who is associated with client device 106. As such, the host name may be mapped to a user identifier, in a particular embodiment.

In particular embodiments, for example, a device fingerprint may consist of a Mac Address, an identification of software installed on client device 106, one or more parameters associated with the software, a hardware architecture, CPU details such as whether the client device 106 has a 32 bit or a 64 bit architecture, or a combination of these or other properties suitable to identify client device 106. In an Internet of Things (IoT) device, the device fingerprint may include a device DNA/Fingerprints (DDNA) or a Thing DNA identifier.

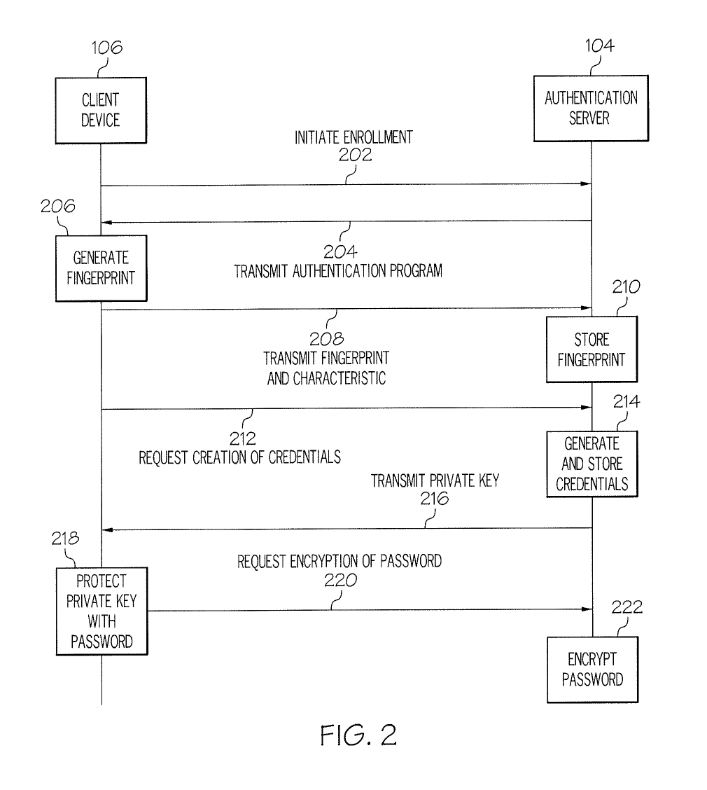

In certain embodiments, client device 106 may first be required to enroll in the authentication program. FIG. 2 illustrates a sequence diagram for enrolling a client device 106 for device authentication. The method begins when enrollment of client device 106 is initiated at 202. In a particular embodiment, enrollment may be initiated when client device 106 is first booted up after the authentication program is adopted. In other embodiments, enrollment may be initiated when client device 106 is booted up for the first time at a remote location.

According to certain embodiments, authentication server 104 transmits an authentication application to be downloaded to client device 106 at 204. The application may comprise a program, plug in, or agent that operates to implement the authentication protocol. At 206, the application may be used to generate a digital fingerprint of client device 106. Additionally, in certain embodiments, the application may be used to identify a characteristic associated with client device 106. For example, in a particular embodiment, the application may read the MAC address of client device 106 and a host name of client device 106.

The digital fingerprint and characteristic may be transmitted to authentication server 104 at 208. Authentication server 104 stores the digital fingerprint and characteristic at 210, according to certain embodiments. As will be described in more detail below, the digital fingerprint, characteristic, and any other identifying information may be subsequently used by authentication server 104 when client device 106 seeks access to enterprise network 110.

According to certain embodiments, client device 106 requests creation of authentication credentials at 212. Authentication server 104 may then generate and store the authentication credentials at 214. According to certain embodiments, the authentication credentials may include closed PKI credentials such as a public key and a private key. In a particular example embodiment, the public and private keys may include closed PKI credentials such as those generated by CA AuthID offered by CA, Inc.

Authentication server 104 transmits a private key to client device 106 at 216. According to certain embodiments, client device 106 may use a randomly generated password received from authentication server 104 to protect the private key at 218. Client device 106 may then request encryption of the password at 220. According to certain embodiments, authentication server 104 may encrypt the randomly generated password using the characteristic previously provided by the client device 106 or another characteristic provided by client device 106. For example, authentication server 104 may encrypt the randomly-generated password using the MAC address associated with client device 106. The encrypted password may be stored in the memory associated with authentication server 106 and later used to authenticate client device 106 when client device 106 subsequently requests to access enterprise network 110.

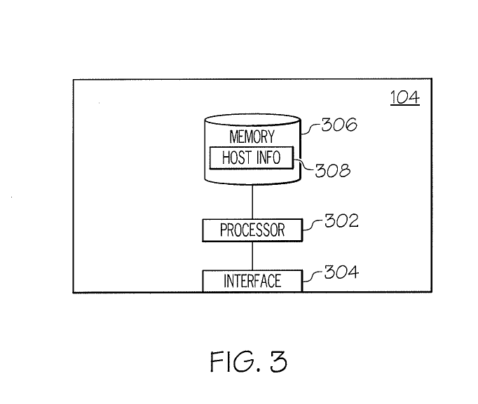

FIG. 3 illustrates an authentication server 104 for performing authentication of a client device 106 according to a non-limiting embodiment. As depicted, authentication server 104 includes a processor 302, a network interface 304, and a system memory 306. The network interface 304 connects authentication server 104 to private network 102 and/or enterprise network 110. The processor 304 may be utilized for processing requirements of the authentication server 104. In certain embodiments, processor 304 may be operable to load instructions from a hard disk into memory 306 and execute those instructions.

Network interface 304 may refer to any suitable device capable of receiving an input, sending an output from authentication server 104, performing suitable processing of the input or output or both, communicating with other devices, and so on. For example, the network interface 304 may include appropriate modem hardware, network interface card, and similar devices. Further, the software capabilities of the network interface 304 may include protocol conversion and data processing capabilities, to communicate through a LAN, WAN, or other communication system, allowing authentication server 104 to communicate to other devices. Moreover, the network interface 302 may include one or more ports, conversion software, or both.

Processor 302 can be any suitable device capable of executing instructions to perform operations for authentication server 104. Processor 302 may include microprocessors, microcomputers, microcontrollers, digital signal processors, central processing units, processing circuitry, state machines, logic circuitries, and/or any devices that manipulate signals based on operational instructions. For example, processor 302 may be any central processing unit (CPU), such as the Pentium processor, the Intel Centrino processor, and so on.

Further, the system memory 306 may be any suitable device capable of storing computer-readable data and instructions. For example, the system memory 306 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

In certain embodiments, memory 306 stores host information 308, which may include any data generated or received for the authentication of client device 106. For example, host information may include one or more characteristics, such as a MAC address, received from client device 106. As another example, host information may include a digital fingerprint received from client device 106 when client device 106 initially sought access to enterprise network 110 and was enrolled in the authentication program.

Although authentication server 104 is depicted as including only a single network interface 304, processor 302, and memory 306 storing host information 308, these items may be present in multiple items, or combined items, as known in the art. It is also recognized that other embodiments may include the placement of one or more of these components elsewhere in authentication server 104.

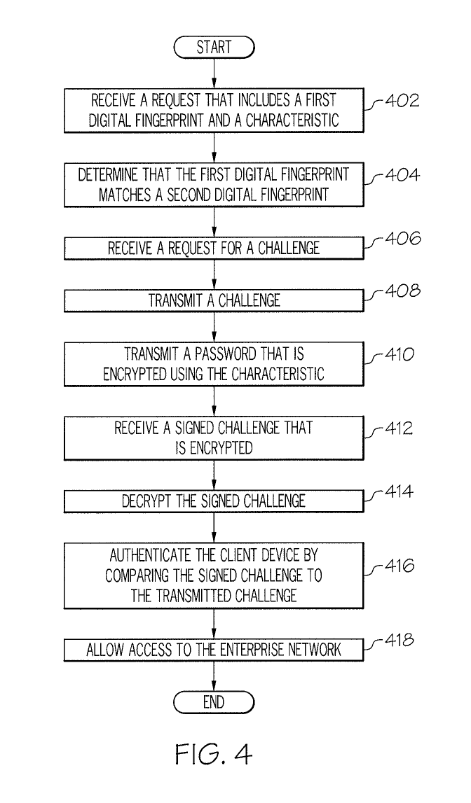

FIG. 4 illustrates a flow diagram depicting a process by authentication server 106 for authenticating a client device 106 for accessing an enterprise network 110, according to a non-limiting embodiment of the present disclosure. As depicted, the method begins at step 402 when a request is received from client device 106 to access enterprise network 110. According to a particular embodiment, the request may be a request to access a particular enterprise resource such as memory 112, file server 114, or a peripheral device 116 after client device 106 has been enrolled in the authentication program as discussed above with regard to FIG. 2.

According to certain embodiments, the request includes at least a first digital fingerprint. Additionally, or alternatively, the request may include a characteristic associated with client device 106, as well as a host name assigned to client device 106. According to a particular embodiment, for example, the characteristic may include the MAC address of client device 106. Additionally, or alternatively, the characteristic may include software installed on client device 106, a device DNA, an IoT identifier, and/or any other identifying property or characteristic associated with client device 106.

At step 404, authentication server 104 determines that the first digital fingerprint matches a second digital fingerprint. For example, according to certain embodiments, authentication server 104 may compare the first digital fingerprint received in the request to access enterprise network 110 to a second digital fingerprint that was generated and/or received when client device 106 initially enrolled in the authentication program. In a particular embodiment, authentication server 104 may use the host name provided with the request to retrieve the second digital fingerprint from a memory associated with the authentication server 104.

If it were determined that the first digital fingerprint received in the request does not match the second digital fingerprint previously stored by authentication server 106, access to all or some of enterprise network 110 might be denied or restricted. In certain embodiments, for example, where limited access is provided, a set of controls may be made invisible to the user 108 of client device 106 such that the user 108 is unable to perform certain operations with respect to the enterprise resources. Alternatively, limited access to the enterprise network 110 may result in a user 108 of client device 106 being able to read but not write to enterprise resources. However, according to the scenario illustrated in FIG. 4, the new digital fingerprint is determined to match the previously stored digital fingerprint. As a result, the process for authenticating the client device 106 continues.

At step 406, authentication server 104 receives a request for a challenge from client device 106. Authentication server 104 issues and transmits the challenge at step 408. In a particular embodiment, the challenge may include a random string.

According to certain embodiments, authentication server 104 may also retrieve an encrypted password. The encrypted password may be transmitted, at step 410, in response to a request for such password. The request for the password may be received with the request for the challenge or separately from the challenge. According to certain embodiments, the encrypted password may be generated during the enrollment of client device 106 as discussed above with reference to 220. In a particular embodiment, the password may be encrypted using the characteristic received from client device 106 in step 402.

At step 412, authentication server 106 receives a signed version of the challenge from client device 106. In certain embodiments, for example, client device 106 may have used a private key issued to client device 106 to encrypt the random string or other challenge received from authentication server 104. Thus, the signed challenge may include an encrypted version of the challenge. Authentication server 106 may then decrypt the signed challenge using a public key, at step 414.

At step 416, authentication server compares the decrypted, signed challenge that was received at step 412 to the challenge that was transmitted to client device 106 at step 408. If the decrypted, signed challenge matches the previously transmitted challenge, the identity of client device 106 is verified and client device 106 is authenticated and client device 106 may then be allowed access to enterprise network 110 at step 418. Specifically, client device 106 may be allowed access to enterprise resources such as memory 112, file server 114, and/or peripheral device 116.

Conversely, if it were determined that the signed challenge does not match the previously transmitted challenge (or if the authentication process fails at any other point), access to all or some of enterprise network 110 might be denied or restricted. As discussed above, limited access may result in a set of controls being made invisible to the user 108 of client device 106 such that the user 108 is unable to perform certain operations with respect to the enterprise resources. Alternatively, limited access to the enterprise network 110 may result in a user 108 of client device 106 being able to read but not write to enterprise resources. Additionally, some but not all enterprise resources may be available to client device 106.

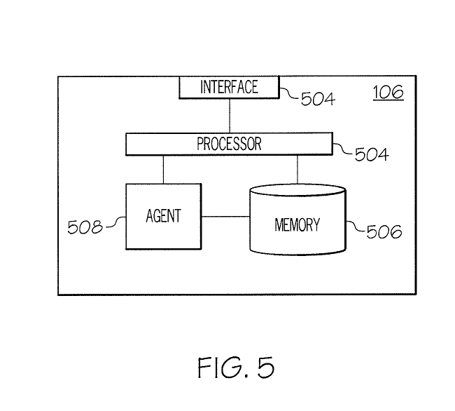

FIG. 5 illustrates a client device 106 for providing device identification information while seeking access to an enterprise network 110, according to a non-limiting embodiment of the present disclosure. As depicted, client device 106 includes a processor 502, a network interface 504, system memory 506, and an authentication agent 508. The network interface 504 connects client device 106 to public network 102 and/or enterprise network 110. The processor 504 may be utilized for processing requirements of the client device 106. In certain embodiments, processor 502 may be operable to load instructions from a hard disk into memory 506 and execute those instructions.

Network interface 504 may refer to any suitable device capable of receiving an input, sending an output from client device 106, performing suitable processing of the input or output or both, communicating with other devices, and so on. For example, the network interface 504 may include appropriate modem hardware, network interface card, and similar devices. Further, the software capabilities of the network interface 504 may include protocol conversion and data processing capabilities, to communicate through a LAN, WAN, or other communication system, allowing the client device 106 to communicate to other devices. Moreover, the network interface 504 may include one or more ports, conversion software, or both.

Processor 502 can be any suitable device capable of executing instructions to perform operations for client device 106. Processor 502 may include microprocessors, microcomputers, microcontrollers, digital signal processors, central processing units, processing circuitry, state machines, logic circuitries, and/or any devices that manipulate signals based on operational instructions. For example, processor 502 may be any central processing unit (CPU), such as the Pentium processor, the Intel Centrino processor, and so on.

Further, the system memory 506 may be any suitable device capable of storing computer-readable data and instructions. For example, the system memory 506 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

According to certain embodiments, authentication agent 508 may include an application downloaded from authentication server 106 during or prior to enrollment of client device 106 to the authentication program. As discussed above, authentication agent 508 may run the application to generate one or more portions of the authentication credentials required for uniquely identifying client device 106 to the authentication server 104. For example, in a particular embodiment, agent 508 may operate to generate a digital fingerprint which is transmitted to authentication server 104 when client device 106 is enrolling in the authentication program. Thereafter, agent 508 may operate to generate additional digital fingerprints when client device 106 seeks access to enterprise network 110. As another example, agent 508 may operate to encrypt and/or decrypt various authentication credentials when seeking authentication of client device 106. In a particular embodiment, for example, agent 508 may read the MAC address of the client device 106 from system properties information and use the MAC address to access a private key which may be used to sign a challenge received from the authentication server 104.

Although authentication server 104 is depicted as including only a single network interface 504, processor 502, memory 506, and agent 508, these items may be present in multiple items, or combined items, as known in the art. It is also recognized that other embodiments may include the placement of one or more of these components elsewhere in client device 106.

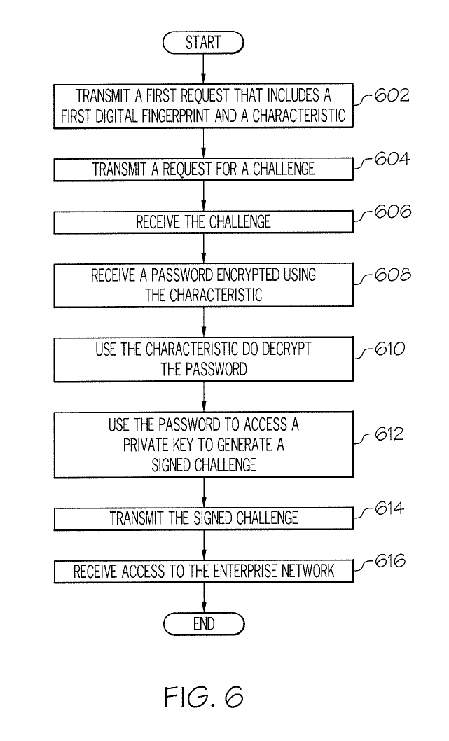

FIG. 6 illustrates a flow diagram depicting a process for accessing an enterprise network, according to a non-limiting embodiment of the present disclosure. The method begins at step 602 when client device 106 transmits a first request to access enterprise network 110. According to a particular embodiment, the request may be a request to access a particular enterprise resource such as memory 112, file server 114, or a peripheral device 116.

According to certain embodiments, the request includes at least a first digital fingerprint. Additionally, or alternatively, the request may include a characteristic associated with client device 106. As discussed above, and according to a particular embodiment, the characteristic may include the MAC address of client device 106. Additionally, or alternatively, the characteristic may include software installed on client device 106, a device DNA, an IoT identifier, a host name associated with client device 106, or a combination of these or other properties that may be used individually or in combination for the identification of client device 106.

Though not depicted, the result of the digital fingerprint match may be transmitted to the client device 106, according to certain embodiments. Thereafter or on its own initiative, client device 106 may transmit a request for a challenge to authentication server 104 at step 604. Client device 106 receives the challenge from authentication server 104 at step 606. In a particular embodiment, the challenge may include a random string.

According to certain embodiments, client device 106 may also receive a password from authentication server 106, at step 608. The password may be encrypted using the characteristic transmitted to authentication server 104 with the request in step 602. In a particular embodiment, for example, the password may be encrypted using the MAC address of client device 106 as previously provided to authentication server 104.

At step 610, client device 106 uses the characteristic to decrypt the password. The decrypted password may then be used to access a private key to generate a signed challenge at step 612. In certain embodiments, for example, client device 106 may use the private key to encrypt the random string or other challenge received from authentication server 104. Thus, the signed challenge may include an encrypted version of the challenge. The signed challenge is transmitted to authentication server 104 at step 614. If the decrypted, signed challenge matches the challenge received from authentication server 104 in step 606, client device 106 may be authenticated. Client device 106 may then be allowed access to enterprise network at step 616.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in a server diagnostic context, but rather that embodiments of the invention may be used in any transaction having a need to monitor information of any type. The specification and the described examples are considered as exemplary only, with the true scope and spirit of the invention indicated by the following claims.

What is claimed is:

1. A method by an authentication server, the method comprising:
receiving, from a client device, a first request to access an enterprise network, the first request comprising:
a first digital fingerprint associated with the client device;
a characteristic associated with the client device;
determining, by the authentication server, that the first digital fingerprint received with the first request matches a second digital fingerprint stored in a memory associated with the authentication server;
receiving, from the client device, a request for a challenge;
transmitting, to the client device, the challenge;
transmitting, to the client device, a password that is encrypted using the characteristic associated with the client device;
receiving, from the client device, a signed challenge, wherein the signed challenge comprises an encrypted version of the challenge;
decrypting the signed challenge;
authenticating the client device by comparing the signed challenge received from the client device to the challenge previously transmitted to the client device; and
in response to determining that the signed challenge matches the challenge previously transmitted to the client device, allowing the client device to access the enterprise network.

2. The method of claim 1, further comprising:
receiving a second request to access the enterprise network, the second request comprising a third digital fingerprint;
comparing the third digital fingerprint received with the second request to the second digital fingerprint stored in the memory associated with the authentication server;
determining that the third digital fingerprint does not match the second digital fingerprint; and
in response to determining that the third digital fingerprint does not match the second digital fingerprint, denying access to the enterprise network.

3. The method of claim 1, wherein:
the first request further identifies a host name associated with the client device, and
the second digital fingerprint is retrieved from the memory based on the host name.

4. The method of claim 1, wherein the characteristic comprises a MAC address associated with the client device.

5. The method of claim 4, wherein the characteristic further comprises at least one of:
software installed on the client device;
CPU details associated with the client device;
a device DNA;
an Internet of Things (IoT) identifier; and
a host name.

6. The method of claim 1, wherein the first request to access the enterprise network comprises a request to access a resource of the enterprise network.

7. The method of claim 1, further comprising:
prior to receiving the first request to access the enterprise network and upon an initial access request to the enterprise network, transmitting, to the client device, an application to be stored on the client device, the application configured to generate the second digital fingerprint at the remote location; and
receiving, from the client device, the second digital fingerprint.

8. The method of claim 7, further comprising:
receiving, from the client device, the characteristic associated with the client device and a device identifier associated with the client device; and
generating, by the authentication server, a password, a private key, and a public key.

9. A method by a client device, the method comprising:
transmitting, to the authentication server, a first request to access an enterprise network, the first request comprising:
a first digital fingerprint associated with the client device;
a characteristic associated with the client device;
transmitting, to the authentication server, a request for a challenge;
receiving, from the authentication server, the challenge;
receiving, from the authentication server, a password that is encrypted using the characteristic associated with the client device;
using the characteristic associated with the client device to decrypt the password;
using the password to access a private key to generate a signed version of the challenge;
transmitting, to the authentication server, the signed version of the challenge; and
receiving access to the enterprise network.

10. The method of claim 9, wherein:
the first request further identifies a host name associated with the client device.

11. The method of claim 9, wherein the characteristic comprises a MAC address associated with the client device.

12. The method of claim 11, wherein the characteristic further comprises at least one of:
software installed on the client device;
CPU details associated with the client device;
a device DNA;
an Internet of Things (IoT) identifier; and
a host name.

13. The method of claim 9, wherein the first request to access the enterprise network comprises a request to access a resource of the enterprise network.

14. The method of claim 9, further comprising:
prior to transmitting the first request to access the enterprise network and upon an initial access request to the enterprise network, receiving, from the authentication server, an application to be stored on the client device, the application configured to generate the first digital fingerprint; and
in response to generating the first digital fingerprint, transmitting the first digital fingerprint to the authentication server.

15. The method of claim 14, further comprising:
retrieving, by the application stored on the client device, the characteristic associated with the client device and a device identifier associated with the client device;
transmitting, to the authentication server, the characteristic associated with the client device and the device identifier associated with the client device;
receiving the private key and the password from the authentication server;
encrypting the password using the characteristic associated with the client device;
storing the private key, the private key protected using the password;
encrypting the password using the characteristic associated with the client device; and
requesting the server to store the encrypted password.

16. An authentication server comprising:
a memory storing instructions; and
processing circuitry operable to execute the instructions to cause the processing circuitry to:
receive, from a client device, a first request to access an enterprise network, the first request comprising:
a first digital fingerprint associated with the client device;
a characteristic associated with the client device;
determine that the first digital fingerprint received with the first request matches a second digital fingerprint stored in a memory associated with the authentication server;
receive, from the client device, a request for a challenge;
transmit, to the client device, the challenge;
transmit, to the client device, a password that is encrypted using the characteristic associated with the client device;
receive, from the client device, a signed challenge, wherein the signed challenge comprises an encrypted version of the challenge;
decrypt the signed challenge;
authenticate the client device by comparing the signed challenge received from the client device to the challenge previously transmitted to the client device; and
in response to determining that the signed challenge matches the challenge previously transmitted to the client device, allow the client device to access the enterprise network.

17. The authentication server of claim 16, wherein:
the first request further identifies a host name associated with the client device, and
the second digital fingerprint is retrieved from the memory based on the host name.

18. The authentication server of claim 16, wherein the characteristic comprises a MAC address associated with the client device.

19. The authentication server of claim 16, wherein the processing circuitry is operable to execute the instructions to cause the processing circuitry to:
prior to receiving the first request to access the enterprise network and upon an initial access request to the enterprise network, transmit, to the client device, an application to be stored on the client device, the application configured to generate the second digital fingerprint at the remote location; and
receive, from the client device, the second digital fingerprint.

20. The authentication server of claim 19, wherein the processing circuitry is operable to execute the instructions to cause the processing circuitry to:
receive, from the client device, the characteristic associated with the client device and a device identifier associated with the client device; and
generate a password, a private key, and a public key.
